(19) United States
(12) Patent Application Publication
(10) Pub. No.: US 2026/0281614 A1
(43) Pub. Date: Sep. 17, 2026

(54) BEAMFORM MODIFICATION CAPTURING SIDE CONVERSATIONS

(71) Applicant: Motorola Mobility LLC, Chicago, IL (US)

(72) Inventors: Ranjeet Gupta, Aurora, IL (US); Rahul Bharat Desai, Hoffman Estates, IL (US)

(73) Assignee: Motorola Mobility LLC, Chicago, IL (US)

(21) Appl. No.: 19/080,503

(22) Filed: Mar. 14, 2025

(51) Int. Cl. H04R 3/00; G06F 3/01

(52) U.S. Cl. CPC H04R 3/005; G06F 3/013; H04R 2203/12

(57) ABSTRACT

Techniques for modifying beamforms capturing side conversations are described. In implementations, a computing device obtains a default gaze direction of a user during a communication session, such as an audio call or a video call, and captures audio of the communication session from a default microphone beamforming area. When the computing device detects a gaze deviation of the user relative the default gaze direction, a modified microphone beamforming area that expands beyond the default microphone beamforming area in a direction of the gaze deviation is formed. Then, the computing device captures the audio from the modified microphone beamforming area.

### BACKGROUND

Telecommunication systems utilize beamforming techniques to capture audio from particular directions. Conventional devices use fixed beamforming patterns to focus on primary speaker positions, which can lead to difficulty capturing side conversation audio from participants at the boundaries of beamformed areas. Incomplete or distorted audio captures of side discussions with nearby participants, potentially causes miscommunication or loss of information. Participants may repeat statements or move closer to a microphone, disrupting the natural flow of conversation and reducing the overall efficiency and effectiveness of the discussion.

### BRIEF DESCRIPTION OF THE DRAWINGS

Aspects of beamform modification capturing side conversations are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of beamform modification capturing side conversations can be implemented in accordance with one or more implementations.

FIG. 2 depicts a block diagram of an example system that can be implemented for beamform modification capturing side conversations in accordance with one or more implementations.

FIG. 3 illustrates a flow chart depicting an example process for beamform modification capturing side conversations in accordance with one or more implementations.

FIGS. 4a through 4d illustrate example scenarios for beamform modification capturing side conversations in accordance with one or more implementations.

FIG. 5 illustrates a flow chart depicting another example process for beamform modification capturing side conversations in accordance with one or more implementations.

FIG. 6 illustrates various components of an example device in which aspects of beamform modification capturing side conversations can be implemented in accordance with one or more implementations.

### DETAILED DESCRIPTION

Techniques for beamform modification capturing side conversations are described. Conventional fixed beamforming techniques have difficulty capturing audio from participants at boundaries of beamformed areas, potentially leading to incomplete or distorted audio captures during side conversations. In implementations, a system addresses these issues by dynamically adjusting beamforming based on user gaze direction, which allows for more flexible audio capture that can expand to include participants engaged in a side discussion, enhancing overall quality and naturalness of communication sessions, including video call and audio call experiences.

The system obtains a default gaze direction of a user during a communication session, which in one example represents a video call. The system captures audio from a default microphone beamforming area, which may be relatively focused for capturing audio from the user who maybe holding a mobile device or in front of one or more displays of a laptop, workstation, or other type of computing system to conduct the video call. Upon detecting a gaze deviation relative to the default gaze direction, such as the user looking left or right towards another person speaking from outside the camera field of view or the gaze boundary associated with a display, the system forms a modified microphone beamforming area expanding beyond the default microphone beamforming area in a direction of the gaze deviation. This modified microphone beamforming area can enhance audio quality when a non-user participant speaks, improving communication effectiveness without disrupting the natural flow of conversation or requiring users to reposition themselves. The system may transition between microphone beamforming patterns to adjust for changes in participant positions during the video call, modifying (e.g., expanding and contracting) the modified microphone beamforming area based on gaze direction changes and deviations. This adaptive approach to audio capture enables more flexible and robust communication sessions with the system, accommodating dynamic changes in participant positioning during video and audio calls relative listening devices of the system.

In at least one implementation, a computing device, such as a smartphone, tablet, laptop, desktop, server, wearable, or other computing system, includes at least one processor operable to implement a computing system that implements dynamic audio beamforming for enhanced side channel audio during calls (e.g., audio calls, video calls, livestreams, broadcasts). The computing device addresses limitations of conventional fixed beamforming techniques by adapting the audio capture area based on the user's gaze direction. The dynamic beamforming approach enables more natural and inclusive conversations, particularly in open office environments where side conversations around workstations are common, in addition to social environments where multiple people gather around one person's mobile phone or tablet to place a video call with family and friends.

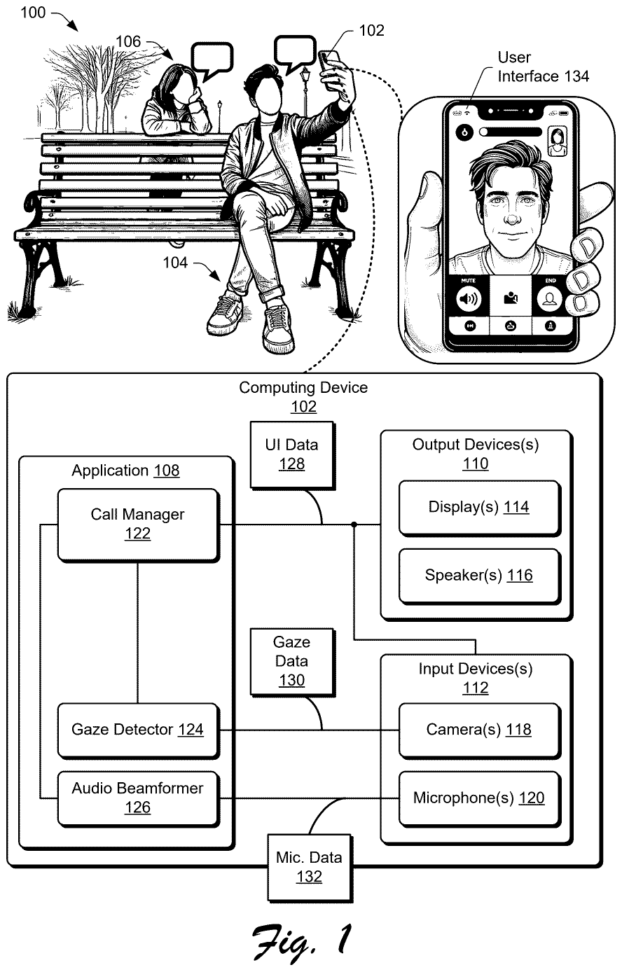

FIG. 1 illustrates an example environment 100 in which aspects of beamform modification capturing side conversations can be implemented in accordance with one or more implementations. The environment 100 includes a computing device 102 being used by a user 104, who is engaged in a video call while seated on a bench. Another person 106, not directly participating in the video call, is shown standing nearby, potentially engaging in a side conversation with the user 104.

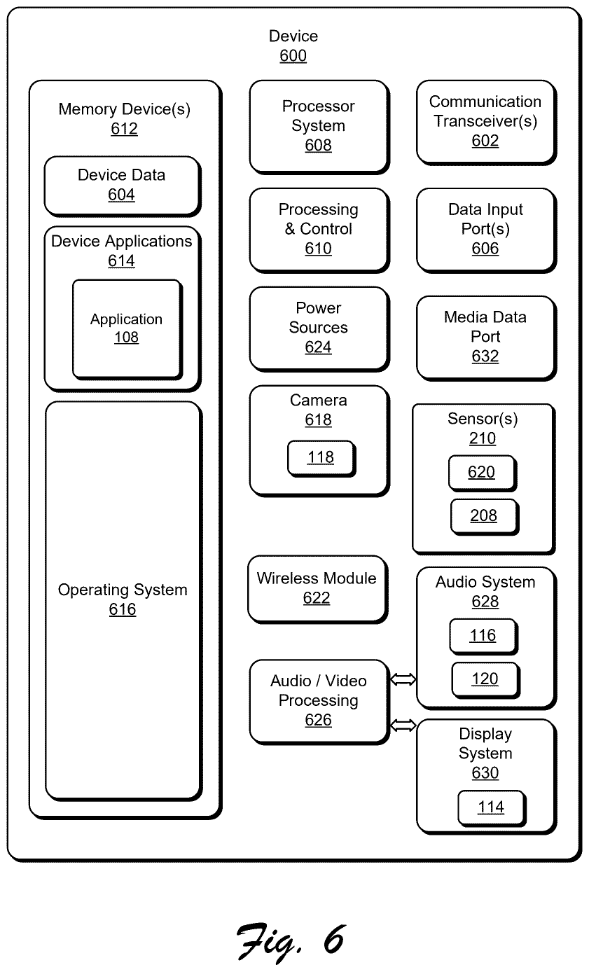

The computing device 102 represents any device capable of video communication, such as a mobile phone, a tablet device, a laptop computer, or a dedicated video conferencing system, which can implement the described gaze-based beamforming techniques. The computing device 102 can be implemented with various components, such as a processor system and memory, as well as any number and combination of different components as further described with reference to the example device 600 shown in FIG. 6.

The computing device 102 includes an application 108 that interfaces with output devices 110 and input devices 112. The output devices 110 comprise a display 114 and speaker 116, while the input devices 112 include a camera 118 and microphone 120. The application 108 is software, firmware, or combination thereof that runs on the computing device to enable video calling functionality. For example, the application 108 may be a video conferencing app. The application 108 contains multiple processing modules including a call manager 122, a gaze detector 124, and an audio beamformer 126. These modules process different types of data during operation: UI data 128, gaze data 130, and microphone data 132. The user interface 134 is presented on the display 114 as the user 104 looks at live video of another participant to conduct the call managed by the application 108.

The call manager 122 is a module or subcomponent of the application 108 (e.g., a function, a routine, a supporting thread) that coordinates the overall video call experience. For instance, the call manager 122 may handle tasks like connecting calls, managing participants, and controlling audio/video streams. The call manager 122 coordinates the overall video call experience, managing the user interface 134 and call connectivity on behalf of the application 108. In addition, by modifying an audio capture area, the call manager 122 enables more natural and inclusive conversations, allowing users to engage with both on-screen participants and those in their immediate vicinity without manually adjusting audio settings or repositioning themselves. In variations, the call manager 122 can analyze operating system data to determine the boundaries of one or more displays, including the display 114, coupled to the computing device 102. This information is used to set appropriate angular thresholds for gaze deviation, ensuring that the beamforming adjustments are optimized for the user's specific multi-screen setup. The display boundaries are set to an appropriate angular threshold (e.g., plus or minus 5 degrees, 10 degrees, 60 degrees) for establishing whether a user is focused on the computing device 102 or possibly another person. In examples, the call manager 122 and underlying components thereof are implemented at least partially in machine-learning using artificial intelligence or other types of machine learning models. For example, the call manager 122 implements an AI assistant that manages the audio beamformer 126 to control the microphone 120 during communication sessions based on information obtained form the gaze detector. The audio beamformer 126 and/or the gaze detector 124 may be part of a single machine-learning model of the call manager 122, or different specialized models. In general, if a machine-learning model is used, the call manager 122 inputs gaze data (e.g., image data) from the camera 118 and outputs commands to the microphone 120 that adjust a microphone beamforming area based on a deviation or lack of deviation in the gaze.

The gaze detector 124 analyzes input from the camera 118 to determine the gaze direction, which is used to detect when the gaze deviates from the default gaze direction of the user 104, e.g., while facing the display 114 and user interface 134. The gaze detector 124 is a module that uses computer vision techniques to track eye movements of the user 104 and determine where the user 104 is looking relative to the field of view of the camera 118 and/or the boundaries or edges of the display 114. For example, the gaze detector 124 may use infrared cameras, optical cameras, and machine learning algorithms to estimate gaze direction indicating a direction relative to the computing device 102 that the user 104 is focused on. In aspects, the gaze detector 124 analyzes input from a non-camera sensor to determine eye movement of the user 104 and the gaze direction. The gaze detector 124 enables the call manager 122 to seamlessly adapt to user behavior and environmental context, e.g., triggering beamform modification capturing side conversations to enhance the overall quality and naturalness of communication sessions. In examples, the gaze detector 124 is a capability of a trained neural network or other type of machine learning model. The model is trained to infer a gaze direction or deviation based on image analysis training data that includes a mixture of positive and negative training samples for depictions of eye gaze that indicate possible side conversation opportunity.

The audio beamformer 126 controls the microphone 120 to adjust the audio capture area based on the detected gaze direction. In some implementations, the microphone 120 can be implemented as an array of multiple microphones including a plurality of microphones, such as two microphones, three microphones, or four or more microphones, which enables precise localization of audio signal sources. Examples of the microphone 120 and microphone array configurations that may be utilized include linear arrays, circular arrays, and planar arrays. By adjusting respective gains and directional functionality of the microphone array, the audio beamformer 126 can amplify sound reception from specific directions and expand or contract audio capture areas. In examples, the audio beamformer 126 is a capability of a trained neural network or other type of machine learning model. The model of the audio beamformer 126 is trained to infer modified microphone beamforming area based on a gaze deviation based on training data that includes a mixture of positive and negative training samples for indicating beamforming shapes and sizes, which through expansion, improve side conversation quality while balancing quality of the user 104 audio input as well.

The microphone array implemented with the microphone 120 may incorporate various beamforming techniques such as delay-and-sum beamforming or adaptive beamforming algorithms to dynamically steer and shape the audio capture pattern. The audio beamformer 126 utilizes signal processing to focus and enhance the capture sensitivity and capability of the microphone 120 in particular directions associated with different beams. Additionally, the microphone 120 can leverage acoustic echo cancellation and noise reduction processing to enhance audio quality for a particular signal or beam.

During a video call, the computing device 102 initially captures audio from a default microphone beamforming area focused on the user 104. The default microphone beamforming area is the initial audio capture zone that focuses on the primary user's position. For example, it may be a narrow beam pattern directed at where the user typically sits. When the gaze detector 124 identifies that the gaze has deviated from the default gaze direction, such as when looking away from the user interface 134 toward the other person 106 (e.g., when the other person says something to the user 104 or to contribute to the video call), the audio beamformer 126 expands the audio capture area. This expanded area, referred to as a modified microphone beamforming area, allows the system to capture spoken audio from both the user 104 and the other person 106, enabling clear transmission of side conversations without requiring users to reposition themselves. The modified microphone beamforming area is an expanded audio capture zone that covers a wider area. For instance, it may use a broader beam pattern to pick up audio from multiple people in the room.

The call manager 122 can implement various strategies for managing the transition between default and modified microphone beamforming areas. For example, a threshold timer may be used to control how long the modified microphone beamforming area is maintained after a gaze deviation is detected. The threshold timer is a timing mechanism that tracks how long to maintain the modified microphone beamforming area. For example, it may be set to 30 seconds after a gaze deviation is detected. Additionally, or alternatively, the call manager 122 may sample audio from outside the default microphone beamforming area to determine if there is ongoing conversation activity that warrants maintaining the modified microphone beamforming area. Audio sampling involves briefly listening to sound from areas outside the default microphone beamforming area. For instance, the call manager 122 uses the microphone 120 to occasionally (e.g., periodically) check for speech activity in other parts of the environment 100.

By dynamically adjusting the audio capture area based on user gaze, the computing device 102 enables more natural and inclusive video call experiences. Users can engage in a side conversation or interact with nearby individuals without manually adjusting settings or moving closer to the microphone. As used herein, dynamic adjustment refers to automatically changing the audio capture area in real-time. For example, the system may widen the beamforming pattern within milliseconds of detecting a gaze deviation. Also as used herein, side conversations are informal discussions that occur alongside the main video call. For instance, a user may briefly turn to speak with a colleague who enters their office during a call. The adaptive approach to audio capture enhances the overall quality and flexibility of video communication, particularly in dynamic environments where multiple participants may be present, but not all are directly involved in the call.

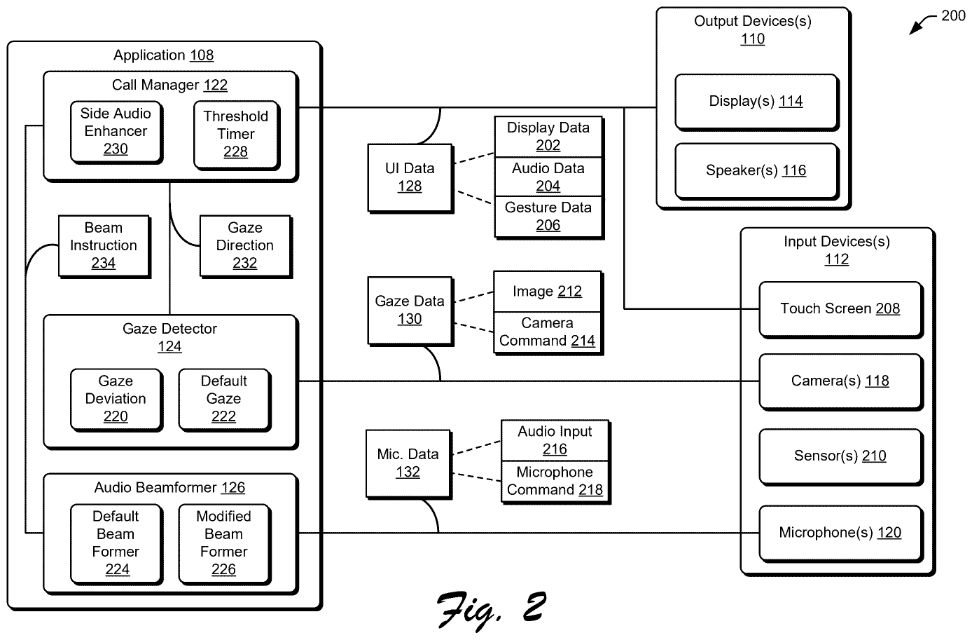

FIG. 2 depicts a block diagram of an example system 200 that can be implemented for beamform modification capturing side conversations in accordance with one or more implementations. The system 200 is described in the context of the environment 100 and being implemented on the computing device 102 using similarly labeled elements as FIG. 1.

The system 200 utilizes memory and a processing system operable to execute instructions implementing the application 108 and its components. The application 108, including the call manager 122, gaze detector 124, and audio beamformer 126, can be implemented as modules with independent processing, memory, and logic components functioning as a computing device integrated with the computing device 102. These modules may be executed in an application execution environment of the computing device 102, such as an operating system executed by a central processing unit. Parts of the application 108 and its components may represent programs, threads, services, or executables. Additionally, aspects of the application 108 and its components can be implemented as a software application or module integrated with the operating system running on the CPU, based on computer-executable instructions in memory or storage of the computing device 102.

The system 200 employs multiple sensors 210 for data collection to modify beamforming. These sensors may include, but are not limited to, cameras, accelerometers, gyroscopes, and magnetometers, providing a comprehensive set of data for accurate gaze detection and device orientation analysis.

The system 200 processes various types of data: UI data 128 (including display data 202, audio data 204, and gesture data 206), gaze data 130 (comprising image data 212 and camera command 214), and microphone data 132 (containing audio input 216 and microphone command 218). The computing device 102 uses this data to manage the video call experience and implement dynamic beamforming functionality. The gesture data 206 may include touch gestures on the touch screen 208 or hand gestures captured by the camera 118, enabling additional user interaction methods during video calls.

The application 108 communicates with the output devices 110 and input devices 112 to generate the user interface 134 and manage the video call experience. The application 108 processes UI data 128, gaze data 130, and microphone data 132 to implement dynamic beamforming functionality. The application 108 may exist as a video conferencing app integrated with the computing device 102's operating system or operate as a standalone application.

The call manager 122, a module within the application 108, coordinates the overall video call experience. The call manager 122 manages the user interface 134, handles call connectivity, and controls the transition between default beam former 224 and modified beamformer 226 areas. It may also implement adaptive noise cancellation techniques to improve audio quality in various environments.

The camera 118 functions as the primary sensor for gaze detection, capturing visual information of the user 104's eye movements and facial orientation. The gaze detector 124 analyzes input from the camera 118 to determine the user 104's gaze direction 232. The gaze detector 124 utilizes computer vision techniques and potentially machine learning algorithms to estimate gaze direction relative to the computing device 102. These algorithms may be continuously updated and improved through on-device learning, enhancing gaze detection accuracy over time. For example, the gaze detector 124 is a capability of a trained neural network or other type of machine learning model. The model is trained to infer a gaze direction or deviation based on image analysis training data that includes a mixture of positive and negative training samples for depictions of eye gaze that indicate possible side conversation opportunity.

The gaze detector 124 works to identify when the user 104's gaze has shifted significantly from the default gaze 222 position. The gaze detector 124 detects the gaze deviation 220 of the user 104 relative to the default gaze 222 direction. The gaze detector 124 processes the visual information to identify the direction of the gaze deviation 220 of the user 104's gaze relative to the default gaze 222. It may also incorporate data from sensors 210 to refine gaze detection, especially in mobile scenarios where the device orientation may change frequently. The gaze detector 124 may combine camera data with sensor data from accelerometers or gyroscopes in the sensors 210 to detect gaze deviations more accurately.

The microphone 120, potentially implemented as an array of multiple microphones, captures audio input 216 and allows the audio beamformer 126 to adjust the audio capture area based on detected gaze deviations 220. The audio beamformer 126 controls the microphone 120 to adjust the audio capture area based on the detected gaze direction 232.

The audio beamformer 126 implements various beamforming techniques such as delay-and-sum beamforming or adaptive beamforming algorithms to dynamically steer and shape the audio capture pattern. When a gaze deviation 220 occurs, the audio beamformer 126 forms the modified beamformer 226 area that expands beyond the default beam former 224 area in the direction of the gaze deviation 220. The audio beamformer 126 manages the transition between different audio capture configurations based on gaze detection results, for instance, by adjusting microphone parameters by issuing microphone commands 218 to the microphone 120. For example, the microphone command 218 instructs or configures the microphone 120 to operate based on the default beam former 224 or the modified beam former 226. It may also implement advanced signal processing techniques to enhance audio quality, such as echo cancellation and background noise reduction.

The call manager 122 helps manage the transition between beamforming states and ensures effective capture of side conversations without prematurely reverting to the default state. The side audio enhancer module 230 within the call manager 122 functions as a component of the application that directs and manages the audio beamformer 126. It issues beam instructions 234 to activate the default beam former 224 or the modified beam former 226 based on the gaze direction 232 determined from the gaze deviation 220 detected by the gaze detector 124. This relates particularly to the use of a threshold timer 228 coinciding with the gaze deviation 220, and audio sampling to manage the duration of the modified beam former 226 area. The threshold timer 228 may be dynamically adjusted based on the frequency and duration of detected gaze deviations, optimizing the system's responsiveness to user behavior.

The display 114 and speaker 116 function as output devices 110, presenting the user interface 134 and audio output, respectively. The input devices 112, including the touch screen 208, enable user input and interaction with the video call interface. Sensors 210, which may include accelerometers or gyroscopes, can provide additional data to refine gaze detection and device orientation. These sensors 210 may also be used to detect and compensate for device movement during video calls, ensuring stable audio beamforming even when the user is mobile.

In operation, the computing device 102 continuously monitors the user 104's gaze direction 232 and adjusts the audio beamforming in real-time. When a gaze deviation 220 occurs, the system 200 expands the audio capture area to include potential side conversations, enhancing the overall communication experience during video calls. The system 200 may also implement predictive algorithms to anticipate gaze deviations based on historical user behavior, allowing for faster beamforming adjustments.

The computing device 102 handles various scenarios, such as brief glances away from the display 114 or extended side conversations, by using timing mechanisms and audio sampling to determine when to revert to the default beamformer 224 configuration. The beam instruction 234 from the gaze detector 124 to the audio beamformer 126 facilitates the dynamic adjustment of the beamforming area based on the detected gaze direction 232. The call manager 122 may extend the duration of the threshold timer 228 if ongoing audio activity is detected in the modified beamformer 226 area. The system 200 may also incorporate user preferences and learning algorithms to fine-tune its behavior over time, adapting to individual user habits and environmental conditions.

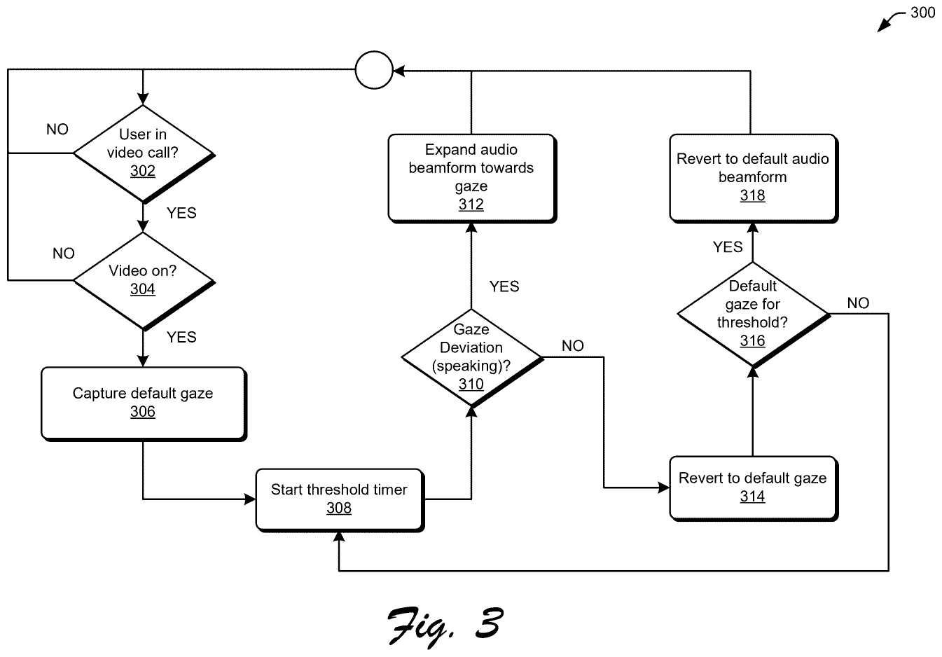

FIG. 3 illustrates a flow chart depicting an example process 300 for beamform modification capturing side conversations in accordance with one or more implementations. The process 300 may be performed in the context of the environment 100, such as by the computing device 102 and/or the system 200. The call manager 122, for example, directs the process 300 to manage a video call. In this scenario, consider the user 104 sitting at a workstation with multiple displays 114 when the other person 106 comes by to participate in an online meeting standing alongside the user 104 near the same desk and interfacing together near the computing device 102.

At operation 302, a determination occurs regarding whether a user participates in a video call. The call manager 122 of the system 200 checks the current state of the application 108 to determine if an active video call session exists. In our scenario, the user 104 has initiated an online meeting using one of displays 114 at their workstation.

At operation 304, a determination occurs regarding whether a video transmission is active during the video call. The call manager 122 verifies whether the camera 118 is operable, including transmitting video data as part of an ongoing communication session call. With an operable camera 118 detected, the call manager 122 enables gaze based audio compensation. In this multi-display setup, the camera 118 may be integrated into one of the displays or positioned to capture the user 104 sitting at the workstation.

At operation 306, gaze based audio compensation techniques are performed by capturing a default gaze of the user 104. The gaze detector 124 analyzes input from the camera 118 to establish a default or baseline gaze direction 232 of the user 104, which gets stored as the default gaze 222. A default microphone beamforming area is initially and by default focused on the user 104 to ensure clear audio capture. This default gaze direction 232 is obtained during the communication session (e.g., during the video call), and the audio beamformer 126 captures audio from a default microphone beamforming area. In the multi-display setup, the default gaze might be directed towards the primary display where the video call interface is shown.

At operation 308, a threshold timer starts. The call manager 122 initiates the threshold timer 228 to track the duration of gaze deviations and manage transitions between modified and default beamforming states. Tracking the duration using the threshold timer 228 helps balance flexible audio capture with focused communication by not remaining in side conversation modes too long, while also allowing adequate time for the other person 106 to speak. For example, if the threshold timer 228 tracks a short duration deviation when the user 104 briefly glances at another display, the call manager 122 refrains from changing or considering changing beamforming modes. If the threshold timer 228 tracks a long deviation, such as when the user 104 turns to engage with the other person 106 standing nearby, then the call manager 122 is likely to cause a change in microphone beamforming states.

At operation 310, a check for gaze deviation while speaking occurs. The gaze detector 124 continuously monitors the user's gaze direction 232 and compares the gaze direction 232 to the default gaze 222 to detect any substantial deviations (e.g., differences beyond an angular threshold of between plus or minus 5 degrees, 12 degrees, 45 degrees, or 91 degrees, and so forth). If the user 104 is speaking while deviating from the default gaze, such as turning to address the other person 106 while continuing to speak, this may indicate the user 104 signaling with eye contact and non-verbal cues an invitation for the other person 106 to participate. If the user 104 stops speaking, however, the call manager 122 may consider the gaze deviation to be an interruption or not change the microphone beamforming states.

At operation 312, the audio beamform expands towards the gaze direction when a gaze deviation gets detected. When the gaze detector 124 detects a gaze deviation 220 relative to the default gaze 222, such as the user 104 turning to face the other person 106, the audio beamformer 126 forms a modified microphone beamforming area that expands beyond the default microphone beamforming area in the direction of the gaze deviation 220. This modified microphone beamforming area allows the system 200 to capture audio from a wider range, including potential side conversations or input from the other person 106 standing nearby. The audio beamformer 126 receives a beam instruction 234 from the gaze detector 124 and adjusts microphone beamforming parameters by issuing a microphone command 218 as an example of microphone data 132 that causes the microphones 120 to widen the capture area specifically in the direction of the user's gaze deviation 220, ensuring that relevant audio from both the user 104 and the other person 106 is included without unnecessarily expanding in multiple directions. This targeted expansion helps maintain audio quality while minimizing the capture of irrelevant background noise from other parts of the office.

At operation 314, the system reverts to the default gaze when no gaze deviation gets detected or after a certain period (e.g., tracked by the threshold timer 228). The call manager 122 waits to instruct the audio beamformer 126 to return to the default beamformer 224 configuration when the gaze detector 124 indicates the user's gaze has returned to the default gaze 222 position, such as looking back at the primary display. The system 200 delays reverting to the default microphone beamforming area until the threshold timer 228 indicates the return to the default position is more than momentary, and the user's gaze remains within an angular threshold of the default gaze direction for a sufficient duration (e.g., 10 seconds, 30 seconds). This prevents rapid switching between beamforming states if the user 104 is frequently alternating attention between the displays and the other person 106.

At operation 316, a determination occurs regarding whether the gaze remains at the default position for a threshold duration. The call manager 122 uses the threshold timer 228 to track how long the user's gaze has remained at the default position, such as focused on the primary display. Additionally, the system 200 may sample audio from outside the default microphone beamforming area and extend the duration of the modified microphone beamforming area based on detected audio activity, ensuring that ongoing side conversations with the other person 106 are not prematurely cut off. The threshold timer 228 may be adjusted if the duration is being extended, allowing for longer interactions with the other person 106 if they are actively contributing to the meeting.

At operation 318, the audio beamform reverts to the default configuration when threshold timer 228 expires. The audio beamformer 126 returns to the default beamformer 224 settings after the call manager 122 confirms the gaze has remained at the default position for a specified duration tracked by the threshold timer 228. In other words, the user 104 returned to focusing on the primary display for a sufficient amount of time to indicate a lack of ongoing or possible side conversations with the other person 106, and to focus the microphone 120 for improved sound quality with the user 104, interacting one on one with the computing device 102.

This dynamic beamforming process 300 can be useful in various communication scenarios, including video calls presented on displays integrated with cameras for gaze detection, as well as audio calls occurring in speaker mode where a camera or gaze detector is enabled but participants are not exchanging video. The adaptability of this process allows the system 200 to function effectively across various hardware configurations and use cases, from single-screen computing devices to complex multi-monitor desktop setups like the one described. The implementation of this dynamic beamforming technology represents an advancement over conventional fixed beamforming approaches, allowing for seamless integration of impromptu participants like the other person 106 into ongoing meetings without disrupting the flow of communication or requiring manual audio adjustments.

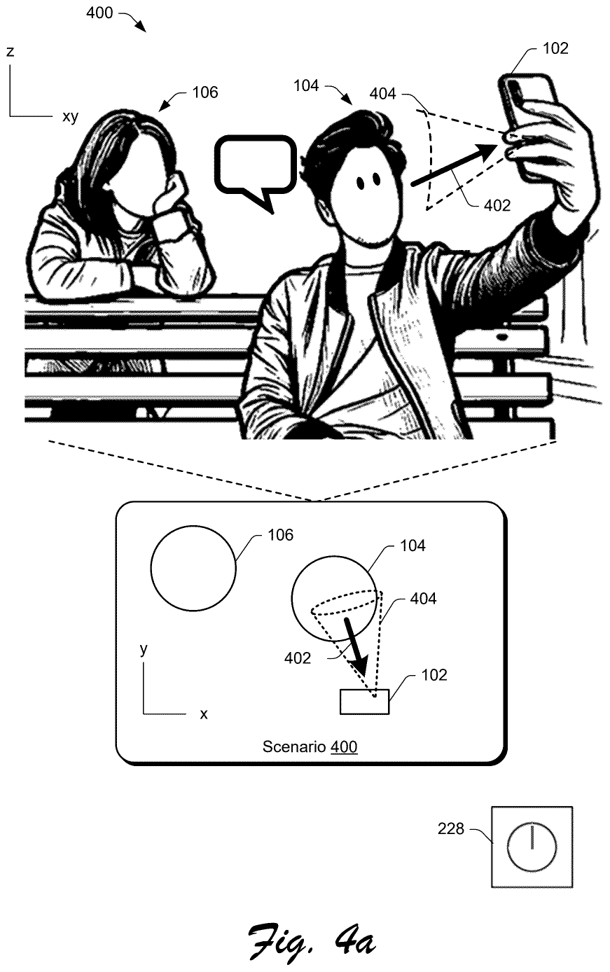

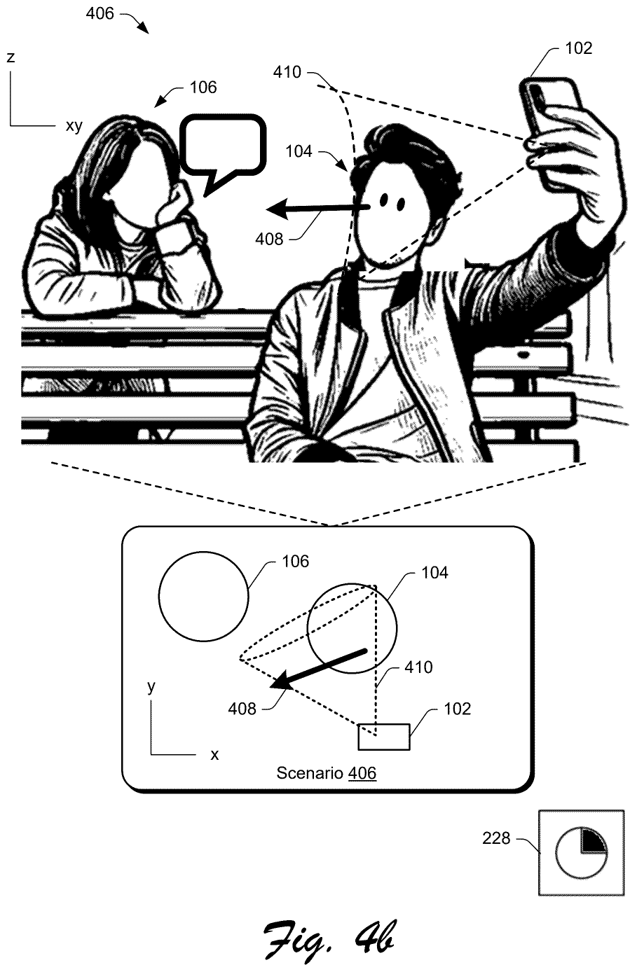

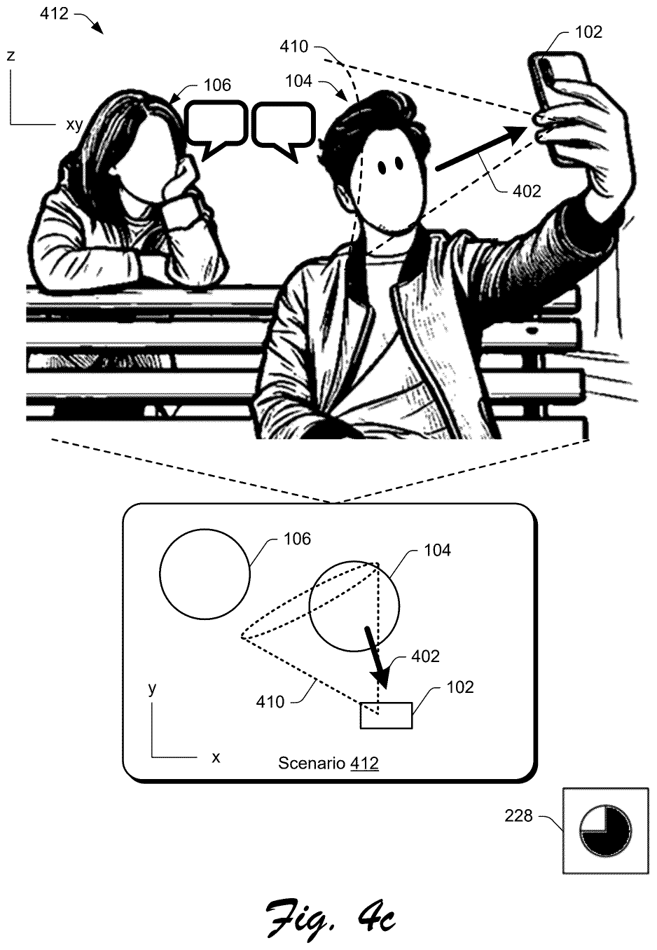

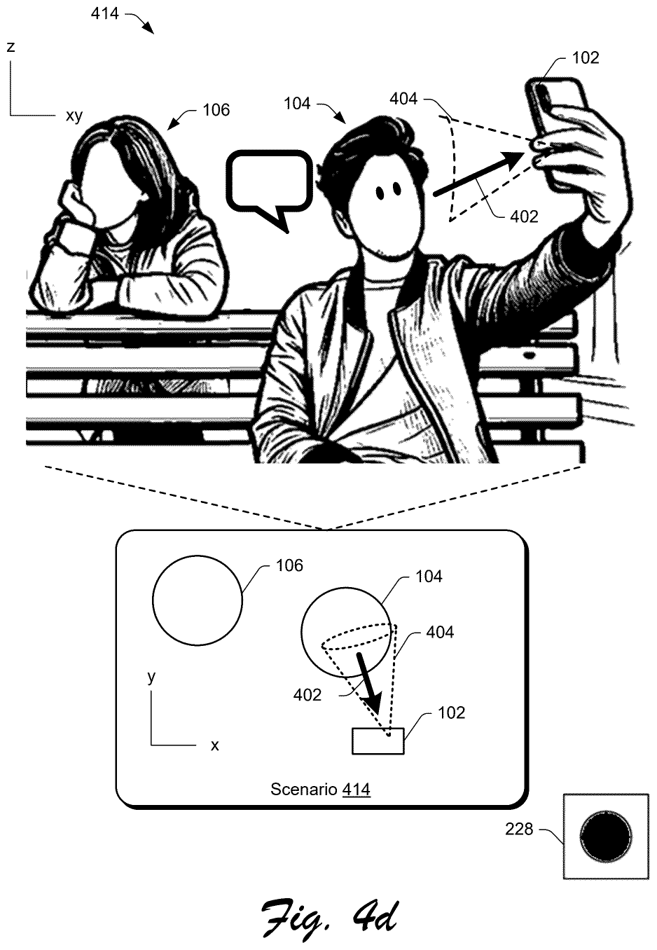

FIGS. 4a through 4d illustrate example scenarios for beamform modification capturing side conversations in accordance with one or more implementations. The scenarios illustrated in FIGS. 4a, 4b, 4c, and 4d are described in the context of the environment 100, and the lower part of each figure displays an overhead view of that corresponding scenario. The computing device 102 in each of these scenarios is illustrated as a mobile device, such as a smartphone or tablet. The scenarios are applicable to other environments where the computing device 102 is stationary (e.g., at a desk) or implemented in another environment where multiple people interact with a computing device or system by sharing the microphone 120 in a collaborative manner.

FIG. 4a depicts a first video call scenario 400 where the computing device 102 captures audio from a default microphone beamforming area 404 focused on the user 104 who is looking in a default gaze direction 402 toward the device. The other person 106 is positioned in the background, not actively speaking but listening to the ongoing call. This setup demonstrates how the default beamforming configuration may not adequately capture audio from participants outside the primary focus area during side conversations. The threshold timer 228 is not set as there is no indication of gaze deviation at this point.

FIG. 4b depicts a second video call scenario 406 where the user 104 exhibits a gaze deviation 408 toward another person 106 as the other person 106 is speaking and participating in the call, from afar. In response, the computing device 102 forms a modified microphone beamforming area 410 that expands beyond the default area to capture audio from both the user 104 and the other person 106. The modified microphone beamforming area 410 allows the system to capture audio from a wider range, including potential side conversations or input from nearby participants. The computing device 102 adjusts microphone beamforming parameters to widen the capture area specifically in the direction of the user 104 gaze deviation, helping to maintain audio quality of speech captured from the other person 106, while minimizing the capture of irrelevant background noise. The threshold timer 228 starts tracking the duration of the gaze deviation to evaluate when to revert back to the default microphone beamforming area 404, and balance user audio quality with side conversation audio quality.

FIG. 4c illustrates a third video call scenario 412 where the modified microphone beamforming area 410 is maintained while the threshold timer 228 tracks the duration of the gaze deviation. The user 104 and the other person 106 take turns speaking during this scenario. As the user 104 speaks, their voice is captured clearly by the expanded beamforming area. When the other person 106 contributes to the conversation, their audio is also picked up effectively due to the modified microphone beamforming area 410. Throughout this exchange, the threshold timer 228 continues to monitor the duration of the gaze deviation. The system evaluates whether to maintain the expanded beam or revert to the default configuration based on the threshold timer 228 status and ongoing microphone audio activity. This dynamic adjustment allows for natural side conversations to be seamlessly integrated into the video call experience.

FIG. 4d depicts a fourth video call scenario 414 where the system has reverted back to capturing audio from the default microphone beamforming area 404. In one example, the video call scenario 414 happens when the threshold timer 228 tracking the duration of the gaze deviation expires or reaches a time threshold, such as 20 seconds, 30 seconds, one or several minutes. In another example, the video call scenario 414 occurs after the other person 106 has turned away and disengaged from the conversation, which is continued by the user 104 using the device 102. The user's gaze has returned to the default gaze direction 402, prompting the system to revert to the default microphone beamforming area 404. This scenario 414 demonstrates the adaptive nature of the beamforming system, which can adjust to changes in user attention and conversation dynamics during a video call. The default microphone beamforming area 404 is now focused on capturing audio primarily from the user 104, as the system has detected that the side conversation with the other person 106 has concluded.

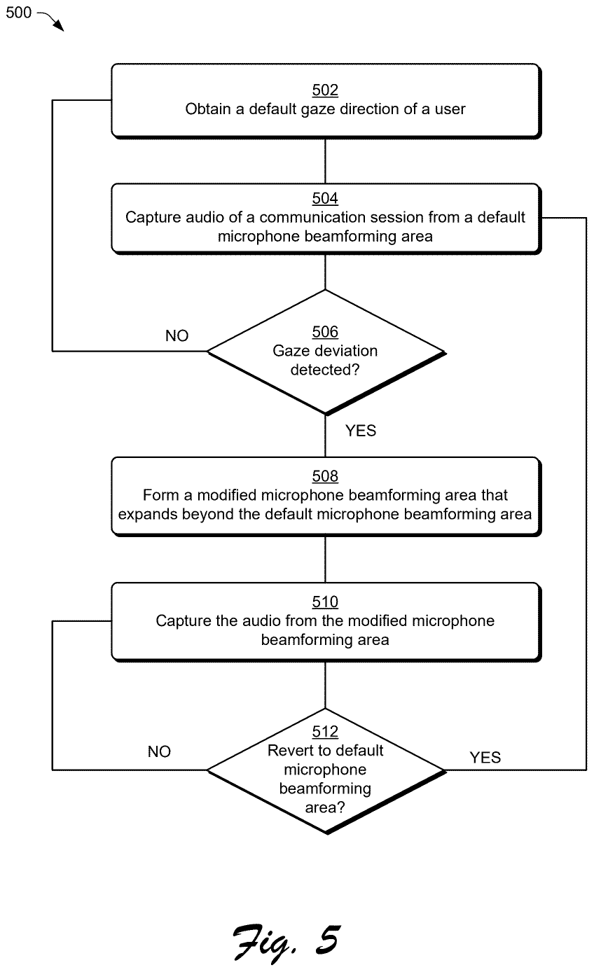

FIG. 5 illustrates a flow chart depicting another example method for beamform modification capturing side conversations in accordance with one or more implementations. Operations of the process 500, for instance, may be performed in the context of the environment 100, such as by the computing device 102 and/or the system 200.

At operation 502, the process 500 obtains a default gaze direction of a user during a communication session, such as a video call, an audio call, and so forth. The default gaze direction may be determined by the gaze detector 124 analyzing input from the camera 118 to establish a baseline gaze direction 232 of the user 104.

At operation 504, the process 500 captures audio of the communication session from a default microphone beamforming area. The audio beamformer 126 may configure the microphone 120 to focus on capturing audio from a relatively narrow area centered on the user's expected position.

At operation 506, the process 500 detects if there is a gaze deviation of the user relative to the default gaze direction. The gaze detector 124 may continuously monitor the user's gaze direction 232 and compare it to the default gaze 222 to identify any substantial deviations, such as deviations of approximately 5 degrees, 10 degrees, 45 degrees, or other angular variations that are different than the default gaze direction sufficient to indicate attention of the user 104 is directed away from the default gaze direction.

At operation 508, if a gaze deviation is detected, the process 500 forms a modified microphone beamforming area that expands beyond the default microphone beamforming area in a direction of the gaze deviation. The audio beamformer 126 may adjust microphone beamforming parameters to widen the audio capture area specifically in the direction indicated by the detected gaze deviation 220.

At operation 510, the process 500 captures the audio from the modified microphone beamforming area. This allows the system to capture audio from both the primary user and potential side conversations without requiring users to reposition themselves.

At operation 512, the process 500 determines whether to revert to the default microphone beamforming area. The call manager 122 may use timing mechanisms or monitor for the user's gaze returning to the default position to make this determination.

The example processes, procedures, algorithms, and methods described above may be performed in various ways, such as for implementing different aspects of the systems and scenarios described herein. Any services, components, modules, methods, and/or operations described herein can be implemented using software, firmware, hardware (e.g., fixed logic circuitry), manual processing, or any combination thereof. Some operations of the example methods may be described in the context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 6 illustrates various components of an example device in which aspects of beamform modification capturing side conversations can be implemented in accordance with one or more implementations. The device 600 can be implemented as any of the devices described with reference to the previous FIGS. 1-5, such as any type of computing device, such as a mobile device, mobile phone, wearable device, tablet, workstation, communication device, entertainment device, gaming device, media playback device, smart display, server, and/or other type of electronic device. For example, aspects of the computing device 102 and/or the system 200, as shown and described with reference to FIGS. 1-5 may be implemented as the example device 600.

The device 600 includes communication transceivers 602 that enable wired and/or wireless communication of device data 604 with other devices. The device data 604 can include any of device identifying data, device location data, wireless connectivity data, and wireless protocol data. Additionally, the device data 604 can include any type of audio, video, and/or image data. The device data 604 can include any type of communication data, such as radio measurements and radio messages. Example communication transceivers 602 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processing system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory 612 can include various implementations of random access memory (RAM), read-only memory (ROM), flash memory, and other types of storage media in various memory device configurations. The device 600 may also include a mass storage media device. Computer-readable storage memory 612 represents media and/or devices that enable persistent and/or non-transitory storage of information in contrast to mere signal transmission, carrier waves, or signals per se. Computer-readable storage memory 612 do not include signals per se or transitory signals.

The computer-readable storage memory 612 provides data storage mechanisms to store the device data 604, other types of information and/or data, and various device applications 614 (e.g., software applications). The device applications 614 include the application 108, the call manager 122, the gaze detector 124, and the audio beamformer 126, for instance. As another example of device programs maintained in the computer-readable storage memory 612 include instructions for an operating system 616. The operating system 616, for example, implements aspects of the application 108 to execute communications (e.g., audio calls, video calls, telephone calls, live streams). The instructions can be maintained as software instructions within the memory 612 and executed by the processing system 608. When executed, the instructions cause the processing system 608 to execute the device applications 614, which may also include a device manager, such as any form of a control application, software application, signal-processing and control module, code that is native to a particular device, a hardware abstraction layer for a particular device, and so on.

In this example, the example device 600 also includes a camera 618, including the camera 118, and the sensors 210, including motion sensors 620, such as may be implemented in an inertial measurement unit (IMU). The motion sensors 620 can be implemented with various sensors, such as the sensors 210, for example, including a gyroscope, an accelerometer, and/or other types of motion sensors to sense motion of the device. The various motion sensors 620 may also be implemented as components of an inertial measurement unit in the device. The device 600 also includes a wireless module 622, which is representative of functionality to perform various wireless communication tasks, such as through a remote service accessed from a network connection established by the wireless module 622 to a network.

The device 600 can also include one or more power sources 624, such as when the device is implemented as a workstation, desktop computer, or laptop. The power sources 624 may include a charging and/or power system, and can be implemented as a flexible strip battery, a rechargeable battery, a charged super-capacitor, and/or any other type of active or passive power source.

The device 600 also includes an audio and/or video processing system 626 that generates audio data for an audio system 628 and/or generates display data for a display system 630. The audio system and/or the display system may include any devices that process, display, and/or otherwise render audio, video, display, and/or image data, such as the display 114, the microphone 120, and the speaker 116. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 632. In implementations, the audio system and/or the display system are integrated components of the example device. Alternatively, the audio system and/or the display system are external, peripheral components to the example device.

Although implementations of beamform modification capturing side conversations have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a computing device, including: at least one memory; and at least one processor coupled with the at least one memory and operable to cause the computing device to: obtain a default gaze direction of a user during a video call; capture audio of the video call from a default microphone beamforming area; detect a gaze deviation of the user relative to the default gaze direction; form a modified microphone beamforming area that expands beyond the default microphone beamforming area in a direction of the gaze deviation; and capture the audio from the modified microphone beamforming area.

In some aspects, the techniques described herein relate to a computing device, wherein the at least one processor is further operable to cause the computing device to: identify the direction of the gaze deviation; and adjust microphone beamforming parameters that widen the modified microphone beamforming area in the direction of the gaze deviation.

In some aspects, the techniques described herein relate to a computing device, wherein the at least one processor is further operable to cause the computing device to: revert back to capturing the audio from the default microphone beamforming area upon expiration of a threshold timer coinciding with the gaze deviation.

In some aspects, the techniques described herein relate to a computing device, wherein the at least one processor is further operable to cause the computing device to: start the threshold timer in response to detecting the gaze deviation; and capture the audio from the modified microphone beamforming area until the expiration of the threshold timer.

In some aspects, the techniques described herein relate to a computing device, wherein the at least one processor is further operable to cause the computing device to: sample audio from outside the default gaze direction; and extend a duration of the threshold timer based on detected audio activity.

In some aspects, the techniques described herein relate to a computing device, wherein the at least one processor is further operable to cause the computing device to: revert back to capturing the audio from the default microphone beamforming area when the gaze deviation is within an angular threshold of the default gaze direction.

In some aspects, the techniques described herein relate to a computing device, wherein the at least one processor is further operable to cause the computing device to: revert back to capturing the audio from the default microphone beamforming area upon expiration of a threshold timer coinciding with the gaze deviation; and expire the threshold timer when the gaze deviation is within the angular threshold of the default gaze direction.

In some aspects, the techniques described herein relate to a system including: at least one memory; and at least one processor coupled with the at least one memory and operable to cause the system to: obtain a default gaze direction of a user during a communication session; capture audio of the communication session from a default microphone beamforming area; detect a gaze deviation of the user relative the default gaze direction; form a modified microphone beamforming area that expands beyond the default microphone beamforming area; and capture the audio from the modified microphone beamforming area.

In some aspects, the techniques described herein relate to a system, wherein the at least one processor is further operable to cause the system to: analyze operating system data to determine boundaries of one or more displays coupled to the system; and use the boundaries to set an angular threshold that indicates when the gaze deviation captures the audio from the modified microphone beamforming area.

In some aspects, the techniques described herein relate to a system, wherein the at least one processor is further operable to cause the system to: revert back to capturing the audio from the default microphone beamforming area when the gaze deviation is within an angular threshold of the default gaze direction.

In some aspects, the techniques described herein relate to a system, wherein the at least one processor is further operable to cause the system to capture spoken audio from a person other than the user when capturing the audio of the communication session from the modified microphone beamforming area.

In some aspects, the techniques described herein relate to a system, wherein the at least one processor is further operable to cause the system to: identify a direction of the spoken audio from the person other than the user; and adjust microphone beamforming parameters that widen the modified microphone beamforming area in the direction of the spoken audio from the person other than the user.

In some aspects, the techniques described herein relate to a system, wherein the at least one processor is further operable to cause the system to: sample the spoken audio when capturing the audio of the communication session from the modified microphone beamforming area; and extend a duration of a threshold timer coinciding with the gaze deviation.

In some aspects, the techniques described herein relate to a method performed by a computing device, the method including: obtaining a default gaze direction of a user during a communication session with another device; capturing audio of the communication session from a default microphone beamforming area; detecting a gaze deviation of the user relative to the default gaze direction; forming a modified microphone beamforming area that expands beyond the default microphone beamforming area in a direction of the gaze deviation; and capturing the audio from the modified microphone beamforming area.

In some aspects, the techniques described herein relate to a method, further including: identifying the direction of the gaze deviation; and adjusting microphone beamforming parameters that widen the modified microphone beamforming area in the direction of the gaze deviation.

In some aspects, the techniques described herein relate to a method, further including: reverting back to capturing the audio from the default microphone beamforming area upon expiration of a threshold timer coinciding with the gaze deviation.

In some aspects, the techniques described herein relate to a method, further including: reverting back to capturing the audio from the default microphone beamforming area when the gaze deviation is within an angular threshold of the default gaze direction.

In some aspects, the techniques described herein relate to a method, wherein the gaze deviation of the user relative to the default gaze direction is detected based on camera data combined with sensor data obtained from at least one of an accelerometer or a gyroscope.

In some aspects, the techniques described herein relate to a method, wherein the gaze deviation of the user relative to the default gaze direction is detected based on the camera data and sensor data obtained from at least one of an accelerometer or a gyroscope.

In some aspects, the techniques described herein relate to a method, wherein the communication session includes an audio call occurring in speaker mode or a video call presented on a display integrated with a camera that detects the gaze deviation.

What is claimed is:

1. A computing device, comprising:
at least one memory; and
at least one processor coupled with the at least one memory and operable to cause the computing device to:
obtain a default gaze direction of a user during a video call;
capture audio of the video call from a default microphone beamforming area;
detect a gaze deviation of the user relative to the default gaze direction;
form a modified microphone beamforming area that expands beyond the default microphone beamforming area in a direction of the gaze deviation; and
capture the audio from the modified microphone beamforming area.

2. The computing device of claim 1, wherein the at least one processor is further operable to cause the computing device to:
identify the direction of the gaze deviation; and
adjust microphone beamforming parameters that widen the modified microphone beamforming area in the direction of the gaze deviation.

3. The computing device of claim 1, wherein the at least one processor is further operable to cause the computing device to:
revert back to capturing the audio from the default microphone beamforming area upon expiration of a threshold timer coinciding with the gaze deviation.

4. The computing device of claim 3, wherein the at least one processor is further operable to cause the computing device to:
start the threshold timer in response to detecting the gaze deviation; and
capture the audio from the modified microphone beamforming area until the expiration of the threshold timer.

5. The computing device of claim 3, wherein the at least one processor is further operable to cause the computing device to:
sample audio from outside the default gaze direction; and
extend a duration of the threshold timer based on detected audio activity.

6. The computing device of claim 1, wherein the at least one processor is further operable to cause the computing device to:
revert back to capturing the audio from the default microphone beamforming area when the gaze deviation is within an angular threshold of the default gaze direction.

7. The computing device of claim 6, wherein the at least one processor is further operable to cause the computing device to:
revert back to capturing the audio from the default microphone beamforming area upon expiration of a threshold timer coinciding with the gaze deviation; and
expire the threshold timer when the gaze deviation is within the angular threshold of the default gaze direction.

8. A system comprising:
at least one memory; and
at least one processor coupled with the at least one memory and operable to cause the system to:
obtain a default gaze direction of a user during a communication session;
capture audio of the communication session from a default microphone beamforming area;
detect a gaze deviation of the user relative the default gaze direction;
form a modified microphone beamforming area that expands beyond the default microphone beamforming area; and
capture the audio from the modified microphone beamforming area.

9. The system of claim 8, wherein the at least one processor is further operable to cause the system to:
analyze operating system data to determine boundaries of one or more displays coupled to the system; and
use the boundaries to set an angular threshold that indicates when the gaze deviation captures the audio from the modified microphone beamforming area.

10. The system of claim 9, wherein the at least one processor is further operable to cause the system to:
revert back to capturing the audio from the default microphone beamforming area when the gaze deviation is within an angular threshold of the default gaze direction.

11. The system of claim 8, wherein the at least one processor is further operable to cause the system to capture spoken audio from a person other than the user when capturing the audio of the communication session from the modified microphone beamforming area.

12. The system of claim 11, wherein the at least one processor is further operable to cause the system to:
identify a direction of the spoken audio from the person other than the user; and
adjust microphone beamforming parameters that widen the modified microphone beamforming area in the direction of the spoken audio from the person other than the user.

13. The system of claim 12, wherein the at least one processor is further operable to cause the system to:
sample the spoken audio when capturing the audio of the communication session from the modified microphone beamforming area; and
extend a duration of a threshold timer coinciding with the gaze deviation.

14. A method performed by a computing device, the method comprising:
obtaining a default gaze direction of a user during a communication session with another device;
capturing audio of the communication session from a default microphone beamforming area;
detecting a gaze deviation of the user relative to the default gaze direction;
forming a modified microphone beamforming area that expands beyond the default microphone beamforming area in a direction of the gaze deviation; and
capturing the audio from the modified microphone beamforming area.

15. The method of claim 14, further comprising:
identifying the direction of the gaze deviation; and
adjusting microphone beamforming parameters that widen the modified microphone beamforming area in the direction of the gaze deviation.

16. The method of claim 14, further comprising:
reverting back to capturing the audio from the default microphone beamforming area upon expiration of a threshold timer coinciding with the gaze deviation.

17. The method of claim 14, further comprising:
reverting back to capturing the audio from the default microphone beamforming area when the gaze deviation is within an angular threshold of the default gaze direction.

18. The method of claim 14, wherein the gaze deviation of the user relative to the default gaze direction is detected based on camera data combined with sensor data obtained from at least one of an accelerometer or a gyroscope.

19. The method of claim 18, wherein the gaze deviation of the user relative to the default gaze direction is detected based on the camera data and sensor data obtained from at least one of an accelerometer or a gyroscope.

20. The method of claim 14, wherein the communication session comprises an audio call occurring in speaker mode or a video call presented on a display integrated with a camera that detects the gaze deviation.
